(19) United States
(12) Patent Application Publication
(10) Pub. No.: US 2023/0344858 A1
(43) Pub. Date: Oct. 26, 2023

(54) METHOD AND SYSTEM FOR AUTOMATICALLY CLASSIFYING AN ENTITY BASED ON NETWORK FEATURES

(71) Applicant: Actifile LTD, New York, NY (US)

(72) Inventors: Assaf Litai, Tel Aviv (IL); Guy Bavly, Herzliya (IL)

(21) Appl. No.: 18/305,576

(22) Filed: Apr. 24, 2023

Related U.S. Application Data
(60) Provisional application No. 63/333,996, filed on Apr. 22, 2022.

(51) Int. Cl. H04L 9/40

(52) U.S. Cl. CPC H04L 63/1433

(57) ABSTRACT

Techniques for automatically classifying an entity based on features of an associated network, determining risk to data in the network, and mitigating the determined risk are disclosed. The system may scan a network associated with an entity to extract one or more features of the network. The system may classify the entity based at least a portion of the one or more extracted features. The system may compute a risk to data in the network based on the one or more features and the entity classification, and determine one or more actions to mitigate the computed risk. The system may communicate the one or more actions to a user.

### RELATED APPLICATION

Under provisions of 35 U.S.C. § 119(e), the Applicant claims benefit of U.S. Provisional Application No. 63/333,996 filed on Apr. 22, 2022, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to classification of businesses. In particular, the present disclosure related to classifying data stored bay a business, and using the stored data to classify the business.

### BACKGROUND

Data protection and data loss prevention (DLP) software includes a set of tools and processes used to ensure that sensitive data maintained by an entity, such as a company, is not lost, misused, or accessed by unauthorized users. DLP software classifies regulated, confidential and business critical data and identifies violations of data policies defined by the entity. Typically, the policies defined by the entity are driven by regulatory compliance (e.g., compliance with HIPAA, PCI-DSS, and/or GDPR regulations). Responsive to identification of one or more violations, DLP enforces remediation with alerts, encryption, and other protective actions to prevent an end user from sharing data that could put the organization at risk. Such data sharing may be accidental or malicious. DLP software may monitor and/or control endpoint activities, filter data streams on corporate networks, and monitor data in the cloud to protect data. DLP may also provide reporting to meet compliance and auditing requirements and identify areas of weakness and anomalies for forensics and incident response.

In conventional systems, deploying data protection technologies such as data discovery and/or DLP software, requires a user to set up relevant policies and data classifiers for the business. This setup can be difficult, costly, and time consuming. Moreover, the setup requires the installer to have a familiarity with the business. and usually incurs a costly (both in terms of resources and time) professional services engagement.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

A business classification system may connect to a network associated with an entity to be classified and extract data storage features associated with the network. The features extracted may include, for example, types of data found, installed applications, user activity, shares, and/or the like. The extracted features may be provided to an artificial intelligence, such as a machine learning (ML) engine for classification.

The artificial intelligence may apply an algorithm to the extracted features. For example, the algorithm may be a clustering algorithm, such as K-means, to find other entities that included networks having similar features. Based on the other entities having similar features, the artificial intelligence may determine an entity type associated with the network. For example, if several entities having similar features are indicated to be healthcare networks, the entity type associated with the network may be determined to be healthcare.

Backpropagation may be used to correct the response of the artificial intelligence, so that the clusters may be differentiated based on their respective entity types. The backpropagation may allow the artificial intelligence to improve in its ability to differentiate entity types based on the network features.

An artificial intelligence network (e.g., another network and/or the same artificial intelligence network) may be used recursively to differentiate sub classes of entity based on the network features. For example, an artificial intelligence network may be trained to differentiate between different sub-classes of entity. For example, once an entity is identified as a healthcare entity, an artificial intelligence network may be applied to differentiate between types of healthcare entity (e.g., to differentiate a general practice medical practice from a dental practice).

Most conventional methods used to classify a business or other entity are manual. While this works for enterprises it does not work well for small and medium sized businesses, because these businesses lack the knowledge and/or resources required to manage a large professional services project. Accordingly, security and compliance services that are based on correct policy selections are hard for the small and medium sized businesses to use and deploy. Also, most data risk applications assume that the entity operating the application has resources available to review and prioritize events. Many entities, however, lack the expertise and/or the resources needed to perform the review and prioritization. Accordingly, there is a need for a system to automatically identify an entity type and provide data security recommendations based on the entity type.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 is a flow chart of a method for providing method of entity classification and data risk assessment and mitigation;

FIG. 3 is a block diagram of a system including a computing device for performing the method of FIG. 2;

FIG. 4 illustrates a block diagram of an example embodiment of an entity classification module;

FIG. 5 illustrates a block diagram of an example embodiment of a risk assessment module; and

FIG. 6 illustrates a block diagram of an example embodiment of a system for scanning files stored on a network and applying a protection policy to one or more of the files.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of a system for automatically classifying an entity based on network features, embodiments of the present disclosure are not limited to use only in this context.

### I. PLATFORM OVERVIEW

This overview is provided to introduce a selection of concepts in a simplified form that are further described below. This overview is not intended to identify key features or essential features of the claimed subject matter. Nor is this overview intended to be used to limit the claimed subject matter's scope.

An entity, such as a corporation or other organization, may gather data during the course of operations. The gathered data may be stored in various locations. For example, the data may be stored in one or more storage device connected to a server, a storage area network (SAN), a network attached storage (NAS) device, or the like. In some embodiments, the data may be stored in a cloud server, rather than as part of a local area network. Data gathered by the entity may have significant value, and/or may include personal data shared with the entity that is not intended for public distribution. Accordingly, the entity may use data protection technologies such as data discovery and/or DLP software to protect the data gathered by the entity.

The system may scan the network that the entity wishes to protect (e.g., the network at which the data is stored) to extract one or more features of the network. For example, the one or more features may include (but are not limited to) one or more of types of data found, installed applications, user activity, shares, and/or the like.

The system may transmit the one or more features to an artificial intelligence network, such as a machine learning network. The network may use clustering to identify other networks having similar features to those of the scanned network. Based on the entity types associated with the clustered networks, the artificial intelligence network may determine an entity type of the entity associated with the scanned network. In some embodiments, the artificial intelligence network may incorporate a feedback mechanism to help improve the entity type determinations.

In embodiments, the artificial intelligence network may include one or more sub-networks for recursively analyzing the scanned network to classify the entity associated with the scanned network into one or more sub-categories. For example, after the artificial intelligence network classifies the entity associated with the scanned network as a healthcare entity, an artificial intelligence sub-network may be employed to classify the entity associated with the network as a particular type of healthcare practice (e.g., a dental practice, an orthopedic practice, etc.).

Once the entity associated with the network is classified, the system may provide one or more suggested data loss prevention policies for use on the network. For example, the system may implement a Bayesian model for data-in-use risk. That is, for each item of data in use by an application, the system may determine the application using the data and, based on the type of application (e.g., general purpose, communications/social network, productivity, etc.), may build a model that assesses and aggregates the risk to the data item.

Improving the results generated by the Bayesian model may be done using a COBWEB algorithm, where each cluster of the Bayesian model is compared to the expected results as a cluster. Based on the output of the Bayesian model, the system may identify one or more changes to the network that will help to secure the data stored therein. For example, the results of the Bayesian model may be transmitted to another filter, such as a Kalman filter, which may help to identify a minimal number of changes to the network features that result in a maximal or approximately maximal reduction in risk to the data.

Embodiments of the present disclosure may comprise methods, systems, and a computer readable medium comprising, but not limited to, at least one of the following:
A. A Network Feature Extraction Module;
B. An Entity Classification Module;
C. A Risk Assessment Module; and
D. A Communication Module.

Details with regards to each module are provided below. Although modules are disclosed with specific functionality, it should be understood that functionality may be shared between modules, with some functions split between modules, while other functions duplicated by the modules. Furthermore, the name of the module should not be construed as limiting upon the functionality of the module. Moreover, each component disclosed within each module can be considered independently without the context of the other components within the same module or different modules. Each component may contain language defined in other portions of this specifications. Each component disclosed for one module may be mixed with the functionality of another module. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of operations disclosed with reference to each module. For example, although methods may be described to be performed by a single computing device, it should be understood that, in some embodiments, different operations may be performed by different networked elements in operative communication with the computing device. For example, at least one computing device 300 may be employed in the performance of some or all of the stages disclosed with regard to the methods. Similarly, an apparatus may be employed in the performance of some or all of the stages of the methods. As such, the apparatus may comprise at least those architectural components as found in computing device 300.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed without altering or deterring from the fundamental scope of the depicted methods and systems disclosed herein.

Consistent with embodiments of the present disclosure, a method may be performed by at least one of the modules disclosed herein. The method may be embodied as, for example, but not limited to, computer instructions, which when executed, perform the method. The method may comprise the following stages:
Extracting one or more network features from a network associated with an entity;
Classifying the entity into a particular classification based on the one or more extracted network features;
Computing a risk associated with data stored on the network; and
Recommending one or more changes to the network features to reduce the computed risk.

Although the aforementioned method has been described to be performed by the platform 100, it should be understood that computing device 300 may be used to perform the various stages of the method. Furthermore, in some embodiments, different operations may be performed by different networked elements in operative communication with computing device 300. For example, a plurality of computing devices may be employed in the performance of some or all of the stages in the aforementioned method. Moreover, a plurality of computing devices may be configured much like a single computing device 300. Similarly, an apparatus may be employed in the performance of some or all stages in the method. The apparatus may also be configured much like computing device 300.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. PLATFORM CONFIGURATION

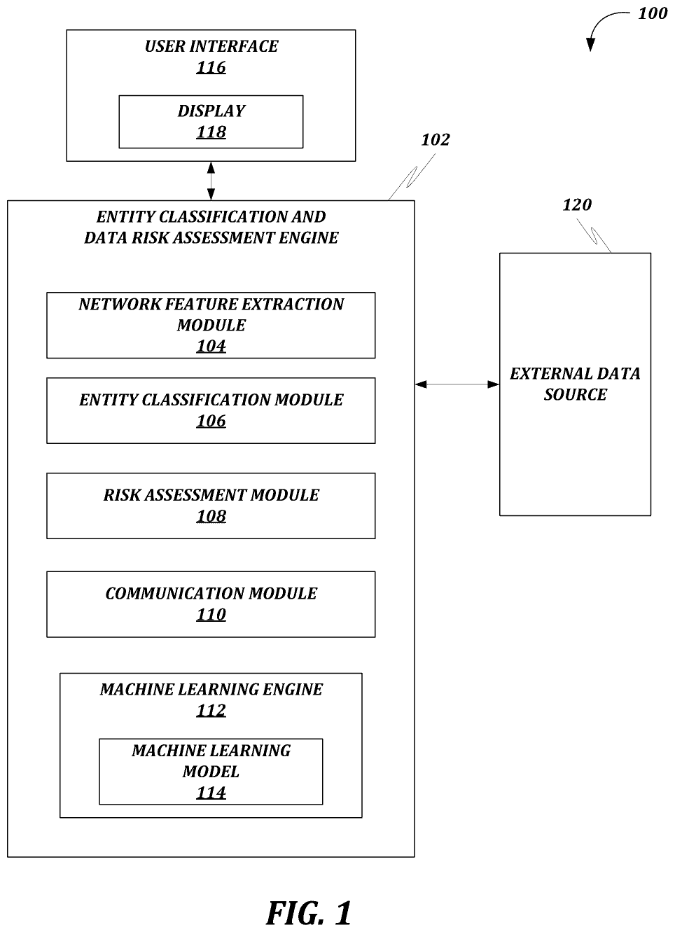

FIG. 1 illustrates one possible operating environment through which a platform consistent with embodiments of the present disclosure may be provided. By way of non-limiting example, an entity classification and data risk assessment platform 100 may be hosted on, for example, a cloud computing service. In some embodiments, the platform 100 may be hosted on a computing device 300. A user may access platform 100 through a software application and/or hardware device. The software application may be embodied as, for example, but not be limited to, a website, a web application, a desktop application, and a mobile application compatible with the computing device 300.

In embodiments, the platform 100 may include an entity classification and data risk assessment engine 102. a user interface 116, an external data source 120, and various components thereof. In one or more embodiments, the platform 100 may include more or fewer components than the components illustrated in FIG. 1. The components illustrated in FIG. 1 may be local to or remote from each other.

In one or more embodiments, the user interface 116 refers to hardware and/or software configured to facilitate communications between a user and the entity classification and data risk assessment engine 102. The user interface 116 may be used by a user who accesses an interface (e.g., a dashboard interface) for work and/or personal activities. The user interface 116 may be associated with one or more devices for presenting visual media, such as a display 118, including a monitor, a television, a projector, and/or the like. User interface 116 renders user interface elements and receives input via user interface elements. Examples of interfaces include a graphical user interface (GUI), a command line interface (CLI), a haptic interface, and a voice command interface. Examples of user interface elements include checkboxes, radio buttons, menus, dropdown lists, list boxes, buttons, toggles, text fields, date and time selectors, command lines, sliders, pages, and forms.

In an embodiment, different components of the user interface 116 are specified in different languages. The behavior of user interface elements may be specified in a dynamic programming language, such as JavaScript. The content of user interface elements may be specified in a markup language, such as hypertext markup language (HTML) or XML User Interface Language (XUL). The layout of user interface elements may be specified in a style sheet language, such as Cascading Style Sheets (CSS). Alternatively, the user interface 116 is specified in one or more other languages, such as Java, C, or C++.

Accordingly, embodiments of the present disclosure provide a software and hardware platform comprised of a distributed set of computing elements, including, but not limited to:

A. A Network Feature Extraction Module

A network feature extraction module 104 may refer to hardware and/or software configured to perform operations described herein (including such operations as may be incorporated by reference) for extracting one or more network features from a network associated with an entity to be classified.

B. An Entity Classification Module

An entity classification module 106 may refer to hardware and/or software configured to perform operations described herein (including such operations as may be incorporated by reference) for classifying an entity based on extracted features of the network associated with the entity to be classified.

C. A Risk Assessment Module

A risk assessment module 108 may refer to hardware and/or software configured to perform operations described herein (including such operations as may be incorporated by reference) for Computing a risk associated with data stored on the network.

D. A Communication Module

A communication module 110 may refer to hardware and/or software configured to perform operations described herein (including such operations as may be incorporated by reference) for transmitting a recommendation of one or more changes to the network features to reduce the computed risk.

In an embodiment, one or more components of the entity classification and data risk assessment engine 102 use an artificial intelligence, such as a machine learning engine 112. In particular, the machine learning engine 112 may be used to classify an entity based on extracted network features of a network associated with the entity (e.g., by the entity classification module 104) from among a plurality of potential classifications. Machine learning includes various techniques in the field of artificial intelligence that deal with computer-implemented, user-independent processes for solving problems that have variable inputs.

In some embodiments, the machine learning engine 112 trains a machine learning model 114 to perform one or more operations. Training a machine learning model 114 uses training data to generate a function that, given one or more inputs to the machine learning model 114, computes a corresponding output. The output may correspond to a prediction based on prior machine learning. In an embodiment, the output includes a label, classification, and/or categorization assigned to the provided input(s). The machine learning model 114 corresponds to a learned model for performing the desired operation(s) (e.g., labeling, classifying, and/or categorizing inputs). The entity classification and data risk assessment engine 102 may use multiple machine learning engines 112 and/or multiple machine learning models 114 for different purposes.

In an embodiment, the machine learning engine 112 may use supervised learning, semi-supervised learning, unsupervised learning, reinforcement learning, and/or another training method or combination thereof. In supervised learning, labeled training data includes input/output pairs in which each input is labeled with a desired output (e.g., a label, classification, and/or categorization), also referred to as a supervisory signal. In semi-supervised learning, some inputs are associated with supervisory signals and other inputs are not associated with supervisory signals. In unsupervised learning, the training data does not include supervisory signals. Reinforcement learning uses a feedback system in which the machine learning engine 112 receives positive and/or negative reinforcement in the process of attempting to solve a particular problem (e.g., to optimize performance in a particular scenario, according to one or more predefined performance criteria). One example of a network for use in reinforcement learning is a recurrent neural network, which may include a backpropagation or feedback pathway to correct or improve the response of the network.

In an embodiment, a machine learning engine 112 may use many different techniques to label, classify, and/or categorize inputs. A machine learning engine 112 may transform inputs (e.g., the extracted network features) into feature vectors that describe one or more properties (“features”) of the inputs. The machine learning engine 112 may label, classify, and/or categorize the inputs based on the feature vectors. Alternatively or additionally, a machine learning engine 112 may use clustering (also referred to as cluster analysis) to identify commonalities in the inputs. The machine learning engine 112 may group (i.e., cluster) the inputs based on those commonalities. The machine learning engine 112 may use hierarchical clustering, k-means clustering, and/or another clustering method or combination thereof. For example, the machine learning engine 112 may receive, as inputs, one or more extracted network features, and may identify one or more entity classifications based on commonalities between the received extracted network features and network features associated with networks corresponding to classified entities. In an embodiment, a machine learning engine 112 includes an artificial neural network. An artificial neural network includes multiple nodes (also referred to as artificial neurons) and edges between nodes. Edges may be associated with corresponding weights that represent the strengths of connections between nodes, which the machine learning engine 112 adjusts as machine learning proceeds. Alternatively or additionally, a machine learning engine 112 may include a support vector machine. A support vector machine represents inputs as vectors. The machine learning engine 112 may label, classify, and/or categorizes inputs based on the vectors. Alternatively or additionally, the machine learning engine 112 may use a naïve Bayes classifier to label, classify, and/or categorize inputs. Alternatively or additionally, given a particular input, a machine learning model may apply a decision tree to predict an output for the given input. Alternatively or additionally, a machine learning engine 112 may apply fuzzy logic in situations where labeling, classifying, and/or categorizing an input among a fixed set of mutually exclusive options is impossible or impractical. The aforementioned machine learning model 114 and techniques are discussed for exemplary purposes only and should not be construed as limiting one or more embodiments.

In an embodiment, as a machine learning engine 112 applies different inputs to a machine learning model 114, the corresponding outputs are not always accurate. As an example, the machine learning engine 112 may use supervised learning to train a machine learning model 114. After training the machine learning model 114, if a subsequent input is identical to an input that was included in labeled training data and the output is identical to the supervisory signal in the training data, then output is certain to be accurate. If an input is different from inputs that were included in labeled training data, then the machine learning engine 112 may generate a corresponding output that is inaccurate or of uncertain accuracy. In addition to producing a particular output for a given input, the machine learning engine 112 may be configured to produce an indicator representing a confidence (or lack thereof) in the accuracy of the output. A confidence indicator may include a numeric score, a Boolean value, and/or any other kind of indicator that corresponds to a confidence (or lack thereof) in the accuracy of the output.

In an embodiment, the entity classification and data risk assessment engine 102 is configured to receive data from one or more external data sources 120. An external data source 120 refers to hardware and/or software operating independent of the entity classification and data risk assessment engine 102. For example, the hardware and/or software of the external data source 120 may be under control of a different entity (e.g., a different company or other kind of organization) than an entity that controls the entity classification and data risk assessment engine. An external data source 120 may include, for example, the network associated with the entity to be classified.

In an embodiment, the entity classification and data risk assessment engine 102 is configured to retrieve data from an external data source 120 by ‘pulling’ the data via an application programming interface (API) of the external data source 120, using user credentials that a user has provided for that particular external data source 120. Alternatively or additionally, an external data source 120 may be configured to ‘push’ data to the entity classification and data risk assessment engine 102 via an API of the query suggestion service, using an access key, password, and/or other kind of credential that a user has supplied to the external data source 120. The entity classification and data risk assessment engine 102 may be configured to receive data from an external data source 120 in many different ways.

### III. PLATFORM OPERATION

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described to be performed by a single computing device, it should be understood that, in some embodiments, different operations may be performed by different networked elements in operative communication with the computing device. For example, at least one computing device 300 may be employed in the performance of some or all of the stages disclosed with regard to the methods. Similarly, an apparatus may be employed in the performance of some or all of the stages of the methods. As such, the apparatus may comprise at least those architectural components as found in computing device 300.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

### A. Method of Entity Classification and Data Risk Assessment and Mitigation

Consistent with embodiments of the present disclosure, a method may be performed by at least one of the aforementioned modules. The method may be embodied as, for example, but not limited to, computer instructions, which when executed, perform the method.

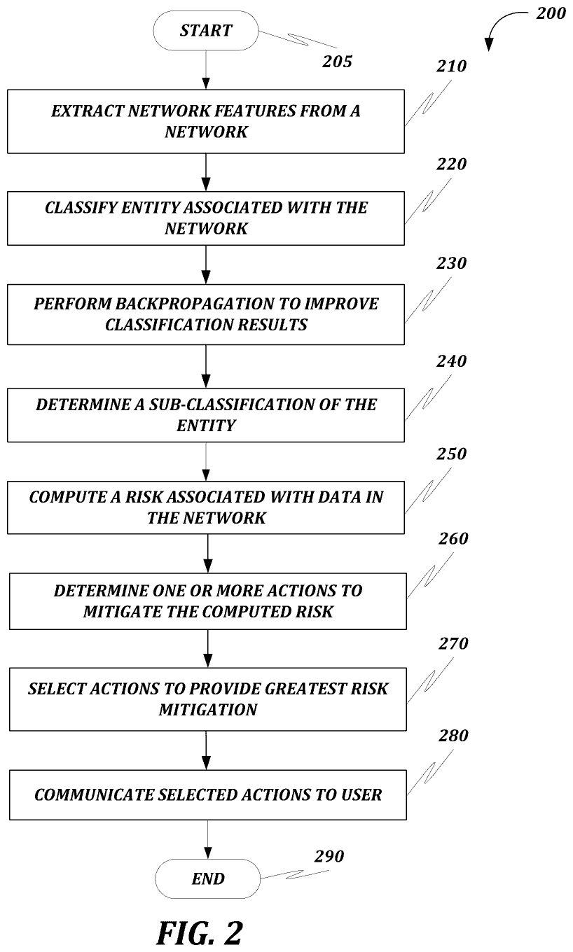

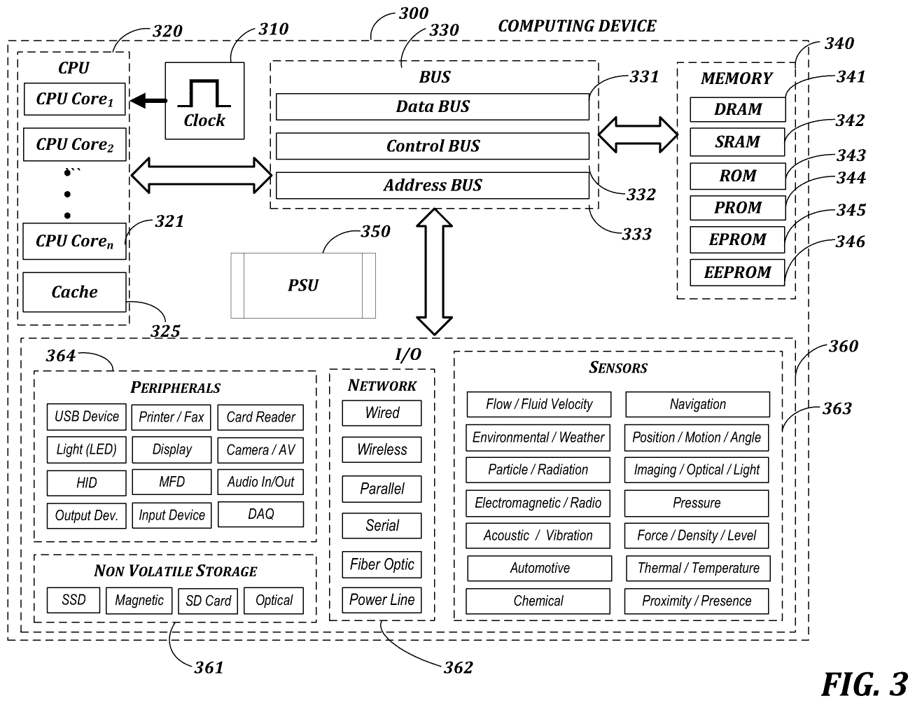

FIG. 2 is a flow chart setting forth the general stages involved in a method 200 consistent with an embodiment of the disclosure for providing the entity classification and data risk assessment platform 100. Method 200 may be implemented using a computing device 300 or any other component associated with platform 100 as described in more detail below with respect to FIG. 3. For illustrative purposes alone, computing device 300 is described as one potential actor in the follow stages.

Method 200 may begin at starting block 205 and proceed to stage 210 where computing device 300 may scan a network associated with an entity to extract one or more network features from the network. For example, the computing device 300 may connect to the network associated with the entity to be classified. Responsive to a successful connection the network, the computing device 300 may scan the network to determine and extract one or more features of the network. The one or more features may include, for example, one or more types of data found stored on the network, one or more installed applications on the network, user activity on the network, and/or the like.

From stage 210, where computing device 300 extracts one or more network features from a network, method 200 may advance to stage 220 where the computing device 300 may classify the entity associated with the network based on the one or more extracted network features. For example, classifying the entity may include providing one or more (e.g., each) of the extracted features to an artificial intelligence, such as a trained machine learning engine to determine a classification. As a particular example, the artificial intelligence may include a recurrent neural network.

To perform the classification, the artificial intelligence may analyze the features of the scanned network to determine commonalities between networks associated with entities of a known classification. As a particular example, the artificial intelligence may use a clustering analysis, such as a K-means clustering to identify commonalities between the scanned network and a library of known networks associated with particular entity types.

Once computing device 300 classifies the entity associated with the network in stage 220, method 200 may continue to stage 230 where computing device 300 may use backpropagation to improve the response of the artificial intelligence. In particular, the artificial intelligence may include a feedback channel that provides an indication of whether the classification determined in stage 220 is accurate. For example, the system could prompt a user to indicate whether or not a determined classification is correct. The results at prompt may be transmitted back to the artificial intelligence network. In some embodiments, the computing device 300 may use a named entity recognition to leverage pre-classified companies to aid in the backpropagation.

After computing device 300 performs the backpropagation in stage 230, method 200 may proceed to stage 240 where computing device 300 may determine an entity subclass of the entity associated with the scanned network. For example, if it is determined in stage 220 that the entity is a healthcare entity, the computing device 300 may determine a subclass of healthcare entity, such as a dental office, a pediatrician, a veterinary clinic, and/or the like. In some embodiments, the computing device 300 may identify the subclass by using an artificial intelligence network to determine a subclass associated with the entity. In some embodiments, the artificial intelligence network may function similarly to the artificial intelligence network employed in stage 220. For example, the artificial intelligence may receive as inputs, one or more of the network features extracted in stage 210 and produce, as output, a subclass associated with the network using a clustering algorithm. In other embodiments, the artificial intelligence network may use a different methodology to determine the subclass associated with the entity.

In embodiments, the system may include a plurality of distinct artificial intelligence networks, with each network being associated with one or more of the plurality of possible classifiers. A particular one of the plurality of artificial intelligence networks may be selected for use in stage 240 based at least in part on the classifier determined in stage 220.

In some embodiments, once computing device 300 determines a subclass of the entity in stage 240, method 200 may proceed to stage 250 where computing device 300 may compute a risk associated with data items in the network. In embodiments, the data items in the network may include both data items stored in the network (e.g., data at rest) and data items in use in the network. Computing the risk associated with the data items in the network may comprise use of a statistical model, such as a Bayesian model, to determine a likelihood that the data item would be compromised.

For data items stored in the network (e.g., data stored on devices and servers local to the network), the statistical model may receive, as input, data including (but not limited to) the type and amount of data, customer classification, variance of the data, age of the data, applications in use that can risk the data, open shares, and/or the like. For data items in use in the network (e.g., data being used by one or more applications on the network), the statistical model may receive, as inputs, an identifier of the type of application making use of the data on the network. For example the identifier may indicate whether the application is a communication application, social networking application, productivity application, etc.

Once computing device 300 computes a risk associated with data items in the network in stage 250, method 200 may proceed to stage 260 where computing device 300 may determine one or more actions that would mitigate the risk to the data. In embodiments, the computing device 300 may apply a conceptual clustering algorithm, such as the COBWEB algorithm to clusters identified using the Bayesian model(s) in stage 250. The conceptual clustering algorithm may be used to determine solutions that would mitigate risk for one or more of the clusters of the Bayesian models.

Once computing device 300 determines one or more actions that would mitigate the risk to the data 260, method 200 may proceed to stage 270 where computing device 300 may determine a minimal or approximately minimal number of changes that will result in the largest risk mitigation. Determining the minimal or approximately minimal number of changes that will result in the maximum risk mitigation may include, for example, providing the risk mitigation actions determined in stage 260 to a Kalman filter. The filter may select a minimal number of actions that produce a maximal risk mitigation. In some embodiments, the filter may include an upper bound on the number of selected actions. The upper bound may be, for example, set by a user, hard coded into the filter, and/or the like.

In embodiments, once the minimal number of actions is determined in stage 270, the determined actions may be communicated to a user of the computing device in stage 280. Communicating the determined actions may include, for example, outputting the determined actions for display on a display device, providing an electronic communication (e.g., email, SMS, etc.) transmitted to a user, or any other means of conveying the actions to the user. In some embodiments, communicating the determined actions may comprise causing the computing device 300 to implement the determined actions and alerting the user that the actions have been implemented.

After communicating the actions to the user in stage 280, method 200 may then end at stage 290.

### IV. COMPUTING DEVICE ARCHITECTURE

Embodiments of the present disclosure provide a hardware and software platform operative as a distributed system of modules and computing elements.

Platform 100 may be embodied as, for example, but not be limited to, a website, a web application, a desktop application, backend application, and a mobile application compatible with a computing device 300. The computing device 300 may comprise, but not be limited to the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exa-scale supercomputer, a mainframe, or a quantum computer;
A minicomputer, wherein the minicomputer computing device comprises, but is not limited to, an IBM AS400/iSeries/System I, A DEC VAX/PDP, a HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack mounted, a workstation, an industrial device, a raspberry pi, a desktop, or an embedded device;

Platform 100 may be hosted on a centralized server or a cloud computing service. Although method 200 has been described to be performed by a computing device 300, it should be understood that, in some embodiments, different operations may be performed by a plurality of the computing devices 300 in operative communication at least one network.

Embodiments of the present disclosure may comprise a system having a central processing unit (CPU) 320, a bus 330, a memory unit 340, a power supply unit (PSU) 350, and one or more Input/Output (I/O) units. The CPU 320 coupled to the memory unit 340 and the plurality of I/O units 360 via the bus 330, all of which are powered by the PSU 350. It should be understood that, in some embodiments, each disclosed unit may actually be a plurality of such units for the purposes of redundancy, high availability, and/or performance. The combination of the presently disclosed units is configured to perform the stages any method disclosed herein.

FIG. 3 is a block diagram of a system including computing device 300. Consistent with an embodiment of the disclosure, the aforementioned CPU 320, the bus 330, the memory unit 340, a PSU 350, and the plurality of I/O units 360 may be implemented in a computing device, such as computing device 300 of FIG. 3. Any suitable combination of hardware, software, or firmware may be used to implement the aforementioned units. For example, the CPU 320, the bus 330, and the memory unit 340 may be implemented with computing device 300 or any of other computing devices 300, in combination with computing device 300. The aforementioned system, device, and components are examples and other systems, devices, and components may comprise the aforementioned CPU 320, the bus 330, the memory unit 340, consistent with embodiments of the disclosure.

At least one computing device 300 may be embodied as any of the computing elements illustrated in all of the attached figures. A computing device 300 does not need to be electronic, nor even have a CPU 320, nor bus 330, nor memory unit 340. The definition of the computing device 300 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 300, especially if the processing is purposeful.

With reference to FIG. 3, a system consistent with an embodiment of the disclosure may include a computing device, such as computing device 300. In a basic configuration, computing device 300 may include at least one clock module 310, at least one CPU 320, at least one bus 330, and at least one memory unit 340, at least one PSU 350, and at least one I/O 360 module, wherein I/O module may be comprised of, but not limited to a non-volatile storage sub-module 361, a communication sub-module 362, a sensors sub-module 363, and a peripherals sub-module 364.

A system consistent with an embodiment of the disclosure the computing device 300 may include the clock module 310 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 320, the central component of modern computers, which relies on a clock. The only exceptions are asynchronous circuits such as asynchronous CPUs. The clock 310 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 300 use a “clock multiplier” which multiplies a lower frequency external clock to the appropriate clock rate of the CPU 320. This allows the CPU 320 to operate at a much higher frequency than the rest of the computer, which affords performance gains in situations where the CPU 320 does not need to wait on an external factor (like memory 340 or input/output 360). Some embodiments of the clock 310 may include dynamic frequency change, where the time between clock edges can vary widely from one edge to the next and back again.

A system consistent with an embodiment of the disclosure the computing device 300 may include the CPU unit 320 comprising at least one CPU Core 321. A plurality of CPU cores 321 may comprise identical CPU cores 321, such as, but not limited to, homogeneous multi-core systems. It is also possible for the plurality of CPU cores 321 to comprise different CPU cores 321, such as, but not limited to, heterogeneous multi-core systems, big.LITTLE systems and some AMD accelerated processing units (APU). The CPU unit 320 reads and executes program instructions which may be used across many application domains, for example, but not limited to, general purpose computing, embedded computing, network computing, digital signal processing (DSP), and graphics processing (GPU). The CPU unit 320 may run multiple instructions on separate CPU cores 321 at the same time. The CPU unit 320 may be integrated into at least one of a single integrated circuit die and multiple dies in a single chip package. The single integrated circuit die and multiple dies in a single chip package may contain a plurality of other aspects of the computing device 300, for example, but not limited to, the clock 310, the CPU 320, the bus 330, the memory 340, and I/O 360.

The CPU unit 320 may contain cache 322 such as, but not limited to, a level 1 cache, level 2 cache, level 3 cache or combination thereof. The aforementioned cache 322 may or may not be shared amongst a plurality of CPU cores 321. The cache 322 sharing comprises at least one of message passing and inter-core communication methods may be used for the at least one CPU Core 321 to communicate with the cache 322. The inter-core communication methods may comprise, but not limited to, bus, ring, two-dimensional mesh, and crossbar. The aforementioned CPU unit 320 may employ symmetric multiprocessing (SMP) design.

The plurality of the aforementioned CPU cores 321 may comprise soft microprocessor cores on a single field programmable gate array (FPGA), such as semiconductor intellectual property cores (IP Core). The plurality of CPU cores 321 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 321, for example, but not limited to Instruction-level parallelism (ILP) such as, but not limited to, superscalar pipelining, and Thread-level parallelism (TLP).

Consistent with the embodiments of the present disclosure, the aforementioned computing device 300 may employ a communication system that transfers data between components inside the aforementioned computing device 300, and/or the plurality of computing devices 300. The aforementioned communication system will be known to a person having ordinary skill in the art as a bus 330. The bus 330 may embody internal and/or external plurality of hardware and software components, for example, but not limited to a wire, optical fiber, communication protocols, and any physical arrangement that provides the same logical function as a parallel electrical bus. The bus 330 may comprise at least one of, but not limited to a parallel bus, wherein the parallel bus carry data words in parallel on multiple wires, and a serial bus, wherein the serial bus carry data in bit-serial form. The bus 330 may embody a plurality of topologies, for example, but not limited to, a multidrop/electrical parallel topology, a daisy chain topology, and a connected by switched hubs, such as USB bus. The bus 330 may comprise a plurality of embodiments, for example, but not limited to:
Internal data bus (data bus) 331/Memory bus
Control bus 332
Address bus 333
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal 10, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 300 may employ hardware integrated circuits that store information for immediate use in the computing device 300, know to the person having ordinary skill in the art as primary storage or memory 340. The memory 340 operates at high speed, distinguishing it from the non-volatile storage sub-module 361, which may be referred to as secondary or tertiary storage, which provides slow-to-access information but offers higher capacities at lower cost. The contents contained in memory 340, may be transferred to secondary storage via techniques such as, but not limited to, virtual memory and swap. The memory 340 may be associated with addressable semiconductor memory, such as integrated circuits consisting of silicon-based transistors, used for example as primary storage but also other purposes in the computing device 300. The memory 340 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 341, Static Random-Access Memory (SRAM) 342, CPU Cache memory 325, Advanced Random-Access Memory (A-RAM), and other types of primary storage such as Random-Access Memory (RAM).
Non-volatile memory which can retain stored information even after power is removed, for example, but not limited to, Read-Only Memory (ROM) 343, Programmable ROM (PROM) 344, Erasable PROM (EPROM) 345, Electrically Erasable PROM (EEPROM) 346 (e.g., flash memory and Electrically Alterable PROM [EAPROM]), Mask ROM (MROM), One Time Programable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device 300 may employ the communication system between an information processing system, such as the computing device 300, and the outside world, for example, but not limited to, human, environment, and another computing device 300. The aforementioned communication system will be known to a person having ordinary skill in the art as I/O 360. The I/O module 360 regulates a plurality of inputs and outputs with regard to the computing device 300, wherein the inputs are a plurality of signals and data received by the computing device 300, and the outputs are the plurality of signals and data sent from the computing device 300. The I/O module 360 interfaces a plurality of hardware, such as, but not limited to, non-volatile storage 361, communication devices 362, sensors 363, and peripherals 364. The plurality of hardware is used by the at least one of, but not limited to, human, environment, and another computing device 300 to communicate with the present computing device 300. The I/O module 360 may comprise a plurality of forms, for example, but not limited to channel I/O, port mapped I/O, asynchronous I/O, and Direct Memory Access (DMA).

Consistent with the embodiments of the present disclosure, the aforementioned computing device 300 may employ the non-volatile storage sub-module 361, which may be referred to by a person having ordinary skill in the art as one of secondary storage, external memory, tertiary storage, off-line storage, and auxiliary storage. The non-volatile storage sub-module 361 may not be accessed directly by the CPU 320 without using intermediate area in the memory 340. The non-volatile storage sub-module 361 does not lose data when power is removed and may be two orders of magnitude less costly than storage used in memory module, at the expense of speed and latency. The non-volatile storage sub-module 361 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (361) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the aforementioned computing device 300 may employ the communication sub-module 362 as a subset of the I/O 360, which may be referred to by a person having ordinary skill in the art as at least one of, but not limited to, computer network, data network, and network. The network allows computing devices 300 to exchange data using connections, which may be known to a person having ordinary skill in the art as data links, between network nodes. The nodes comprise network computer devices 300 that originate, route, and terminate data. The nodes are identified by network addresses and can include a plurality of hosts consistent with the embodiments of a computing device 300. The aforementioned embodiments include, but not limited to personal computers, phones, servers, drones, and networking devices such as, but not limited to, hubs, switches, routers, modems, and firewalls.

Two nodes can be said are networked together, when one computing device 300 is able to exchange information with the other computing device 300, whether or not they have a direct connection with each other. The communication sub-module 362 supports a plurality of applications and services, such as, but not limited to World Wide Web (WWW), digital video and audio, shared use of application and storage computing devices 300, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 362 may comprise a plurality of size, topology, traffic control mechanism and organizational intent. The communication sub-module 362 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,4G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 300 may employ the sensors sub-module 363 as a subset of the I/O 360. The sensors sub-module 363 comprises at least one of the devices, modules, and subsystems whose purpose is to detect events or changes in its environment and send the information to the computing device 300. Sensors are sensitive to the measured property, are not sensitive to any property not measured, but may be encountered in its application, and do not significantly influence the measured property. The sensors sub-module 363 may comprise a plurality of digital devices and/or analog devices.

Consistent with the embodiments of the present disclosure, the aforementioned computing device 300 may employ the peripherals sub-module 362 as a subset of the I/O 360. The peripheral sub-module 364 comprises ancillary devices uses to put information into and get information out of the computing device 300. There are 3 categories of devices comprising the peripheral sub-module 364, which exist based on their relationship with the computing device 300, input devices, output devices, and input/output devices. Input devices send at least one of data and instructions to the computing device 300. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 300. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 364:
Input Devices
   Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, which require up to six degrees of freedom such as, but not limited to, camera gimbals, Cave Automatic Virtual Environment (CAVE), and virtual reality systems.
   Video Input devices are used to digitize images or video from the outside world into the computing device 300. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device, in order to capture produced sound. Audio input devices allow a user to send audio signals to the computing device 300 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 300. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers and plotters.
   Audio and Video (AV) devices, such as, but not limited to, speakers, headphones, amplifiers and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking device (e.g., devices disclosed in network 362 sub-module), data storage device (non-volatile storage 361), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. EXAMPLE EMBODIMENTS

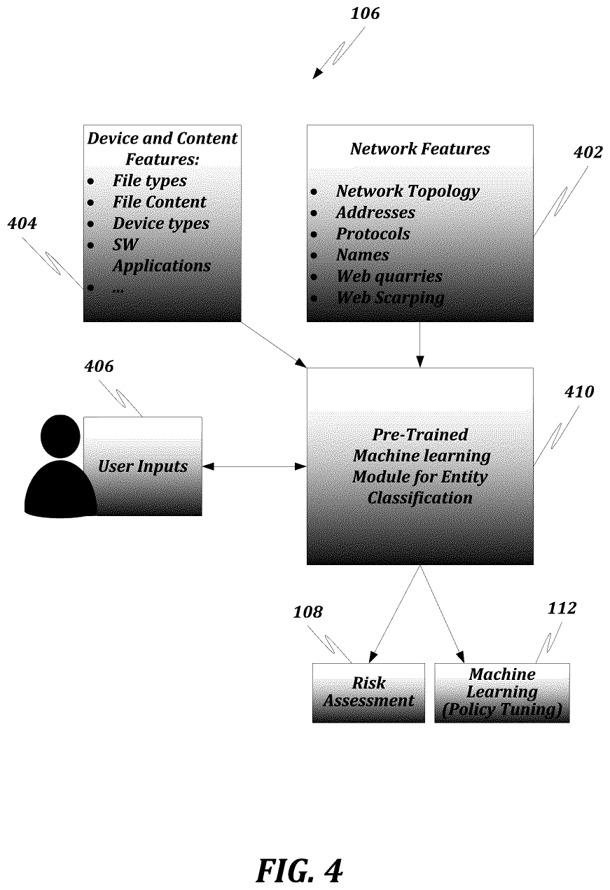

Reference is now made to FIG. 4, which illustrates an example embodiment of the entity classification module 106. The entity classification module 106 may obtain one or more network features 402 such as (but not limited to) a network topology, a list of one or more network addresses, one or more names of domains and sub-domains used in a network, one or more communication protocols that are used for network communication, information from web-quarries about the location and the business name and/or other information pertaining the business. The network features 402 may be obtained, for example, via one or more quarries, via web scraping, or the like, and may be used as one source of inputs to a pre-trained machine learning module for entity classification 410.

Additionally or alternatively, device and content features 404 such as (but not limited to) one or more file types, content of one or more files, one or more device types, one or more software applications that are used, etc. may be obtained. The device and content features 404 may be used as an input to the pre-trained machine learning module for entity classification 410.

Optionally, one or more user inputs 406 may be obtained and used as inputs to the pre-trained machine learning module for entity classification 410. The one or more user inputs 406 may provide another perspective and for adaptations of the parameters of the model and improve the overall performance of the model. The model may utilize an advanced classification model such as a boosted decision tree or a deep neural network, among many other models for processing the inputs. Additionally or alternatively, the model may use a similarity metric that is learned from the data in order to process the inputs to determine an applicable classification. In some embodiments, a particular entity may be associated with more than one business classification. For example, a financial institution can act as both a commercial bank and an investment bank. These different classification may subject the financial institution to different types of regulations. In such cases, even if the user assigned a certain classification to the entity (e.g., via the user inputs 406), the classification module 106 may suggest one or more additional or alternative classifications.

The outputs from the module 410 may be used as inputs to the risk assessment module 108 and/or the machine learning module 112.

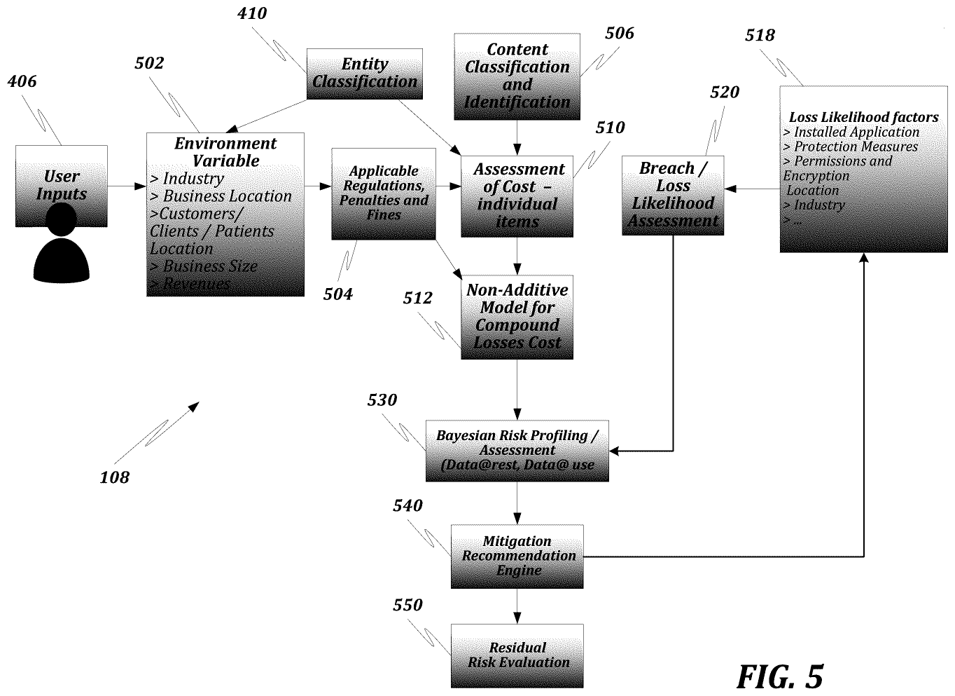

FIG. 5 illustrates an example embodiment of the risk assessment module 108. The module 108 may include two sub-modules, a first module 512 for applying a non-additive model for compound losses, and a second module 520 for assessing likelihood of a breach and losses associated therewith.

The first module 512 may receive one or more environment variables 502, such as industry, business location, customer/client location, business size, revenue, and/or the like. The environment variables 502 (and values associated therewith) may be determined based on one or more user inputs 406 and/or one or more inputs from the pre-trained machine learning module for entity classification 410. The Environmental variables 502 may be used to determine one or more applicable regulations, penalties, and/or fines 504 associated with the business.

Content may be analyzed using a content classification and identification module 506 to determine whether the content contains protected health information (PHI), personal identifiable information (PIO, and/or other classified, secret or sensitive information. This classification, together with the entity classification (e.g., from the module 410) and the applicable regulations, penalties, and/or fines 504 may be used by the cost assessment module 510 to assess potential costs from fines, penalties, reputation damage, loss of competitive advantage, and/or the like due to the loss or abuse of a single content item. In cases in which many such content items suffer lose or abuse, the compound loss may be different from a simple sum of all these losses. For example, regulations such as the US Health Insurance Portability and Accountability Act (HIPPA) cap the total annual fine that a business may be subjected to in case of loss of many records of the same type. On the other hand, the cost from losing source code of an entire project may be significantly higher than losing only a portion of the code. The non-additive model 512 may take these and/or other factors into account and provides a compound risk that, if applicable, is capped by a formal cap. In an exemplary embodiment the algorithm applied by the model 512 may use a non-linear function, such as a sigmoid or other function, in the evaluation of the compound cost of a plurality of similar items. The output of the non-additive model 512 may be provided to a Bayesian network 530 for use in overall risk assessment.

The breach likelihood assessment module 520 may receive one or more inputs 518 such as (but not limited to) a list of one or more installed applications, protection measures that are applied on a system (e.g., malware protection measures), granularity of the permissions afforded to system users, encryption level and coverage of data stores, location of devices, characteristics of the industry, and/or other inputs. The module 520 may assess the likelihood of a breach based on the received inputs. In an exemplary embodiment, the breach likelihood assessment module 520 may provide its output to the Bayesian network 530 to assess the overall risk based on the described inputs 518, 502, 406.

In an example embodiment, the system use a Mitigation Recommendation Engine 540 to suggest mitigation actions for reducing one or more major risk factors. For example, the Mitigation Recommendation Engine 540 may suggest removing untrusted applications or mandate further encryption. In some embodiments the suggested mitigation actions may be determined based on effectiveness of the action (e.g., lowering the likelihood of a breach). In some embodiments, he suggested mitigation actions may be determined based on a cost to implement the suggested action (e.g., the cost may be lower than the cost associated with a breach).

In some embodiments, the Mitigation Recommendation Engine 540 may provide a list of risk mitigation actions, e.g., via email, SMS, displaying the actions on an output device (e.g., a monitor), or any other means to make a system user aware of the actions. In some embodiments, the Mitigation Recommendation Engine 540 may automatically implement one or more of the suggested mitigation actions. For example, the Mitigation Recommendation Engine 540 may cause removal of an untrusted application (e.g., a malware application), or may alter a system setting causing one or more files to be automatically encrypted. Following the mitigation activities, the residual risk may be re-evaluated by the module 550.

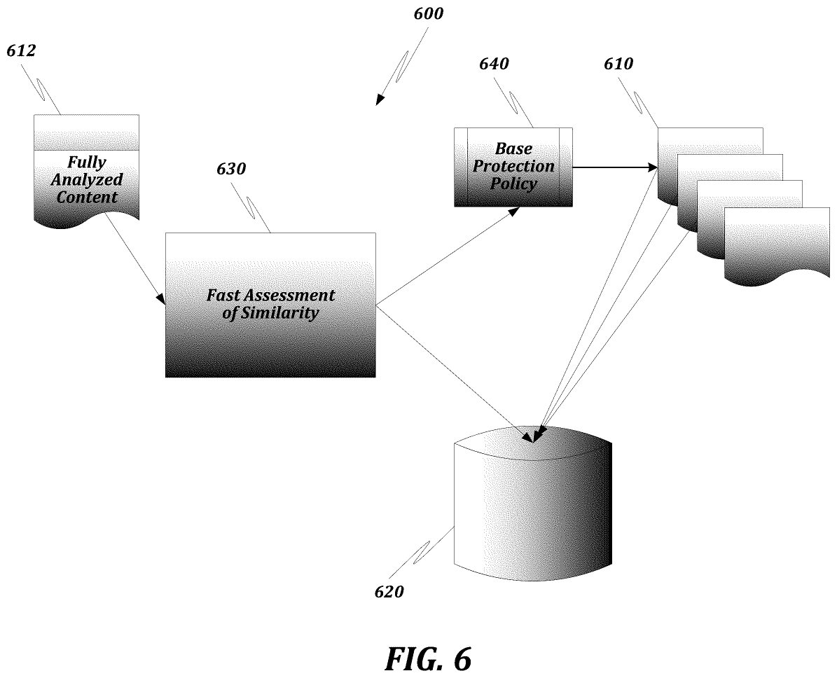

Content classification and identification required for the risk assessment module 108 may require substantial computational resources. In order to allow for a fast and accurate content classification and identification in systems with limited computational resources, a fast-similarity assessment can be used. FIG. 6 illustrates an example embodiment of a system 600 for such fast assessment of similarity. Characteristics (e.g., names, sizes, etc.) of files from a file storage deice 610, including file sizes after compression by several algorithms (e.g., obtaining an image in a jpg format, converting the jpg it to BMP file, and looking at the file size after converting the file to gif and/or png; or compressing an alpha-numeric file using a compression algorithm, such as a Lempel-Ziv-Welch (LZW) algorithm) may be stored in a database 620. A fast assessment of similarity module 630 may employ a superficial similarity measure, such as (but not limited to) the Levenshtein Distance between the strings that represent the name of the files (or the full paths), file sizes, file size ratios, and/or other data to generate an assessed similarity matrix indicating similarity among groups of files. The assessed similarity matrix is used to cluster the files. The system 600 may fully scan two or more representative files 612 and, if the scans deem the file as sensitive, a base protection policy 640, such as encryption or restricting permissions, is applied to the representative files and the files indicated as similar files in the similarity matrix stored in the data store 610. This policy 640 may thereafter be tuned based at least in part on a more comprehensive scan of the data store 610.

### VI. CLAIMS

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. One or more non-transitory computer readable media comprising instructions which, when executed by one or more hardware processors, causes performance of operations comprising:
scanning a network associated with an entity to extract one or more features of the network;
classifying the entity based at least a portion of the one or more extracted features;
computing a risk to data in the network based on the one or more features and the entity classification;
determining one or more actions to mitigate the computed risk; and
communicating the one or more actions to a user.

2. The one or more non-transitory computer readable media of claim 1, wherein computing the risk comprises:
receiving one or more environmental characteristics of the entity;
determining one or more applicable regulations based on the entity classification and the one or more environmental characteristics of the entity;
assessing costs associated with loss or abuse of an individual data item stored on the network; and
applying a non-additive model to determine costs associated with loss or abuse of a plurality of data items stored on the network.

3. The one or more non-transitory computer readable media of claim 2, wherein computing the risk comprises assessing a likelihood of a data breach based on one or more likelihood factors determined based on the one or more extracted features.

4. The one or more non-transitory computer readable media of claim 3, wherein the one or more actions to mitigate the computed risk are determined based on:
the determined likelihood of a data breach. and
one or more of:
the costs associated with loss or abuse of an individual data item, or
the costs associated with loss or abuse of a plurality of data items.

5. The one or more non-transitory computer readable media of claim 1,
wherein scanning the network comprises:
extracting one or more characteristics associated with each file of a plurality of files in a data store, and
determining a similarity matrix indicating similarities between each file in the data store based on the extracted characteristics; and
wherein computing the risk to the data in the network comprises:
analyzing content of a subset of the files in the data store,
computing a risk for each file in the subset of the files, and
determining a risk for all files based on the computed risk for the subset of the files and the similarity matrix.

6. The one or more non-transitory computer readable media of claim 5, further comprising applying a protection policy to one or more files, of the plurality of files in the data store based on the determined risk for each file.

7. The one or more non-transitory computer readable media of claim 6, wherein the protection policy comprises one or more of:
encrypting the file, or
reducing access permissions for one or more users of the network.

8. The one or more non-transitory computer readable media of claim 1, wherein communicating the one or more actions to a user comprises:
causing at least one action, of the one or more actions, to occur; and
notifying a user that the at least one action has occurred.

9. A method, comprising:
scanning a network associated with an entity to extract one or more features of the network;
classifying the entity based at least a portion of the one or more extracted features;
computing a risk to data in the network based on the one or more features and the entity classification;
determining one or more actions to mitigate the computed risk; and
communicating the one or more actions to a user.

10. The method of claim 9, wherein computing the risk comprises:
receiving one or more environmental characteristics of the entity;
determining one or more applicable regulations based on the entity classification and the one or more environmental characteristics of the entity;
assessing costs associated with loss or abuse of an individual data item stored on the network; and
applying a non-additive model to determine costs associated with loss or abuse of a plurality of data items stored on the network.

11. The method of claim 10, wherein computing the risk comprises assessing a likelihood of a data breach based on one or more likelihood factors determined based on the one or more extracted features.

12. The method of claim 11, wherein the one or more actions to mitigate the computed risk are determined based on:
the determined likelihood of a data breach. and
one or more of:
the costs associated with loss or abuse of an individual data item, or
the costs associated with loss or abuse of a plurality of data items.

13. The method of claim 9,
wherein scanning the network comprises:
extracting one or more characteristics associated with each file of a plurality of files in a data store, and
determining a similarity matrix indicating similarities between each file in the data store based on the extracted characteristics; and
wherein computing the risk to the data in the network comprises:
analyzing content of a subset of the files in the data store,
computing a risk for each file in the subset of the files, and
determining a risk for all files based on the computed risk for the subset of the files and the similarity matrix.

14. The method of claim 13, further comprising applying a protection policy to one or more files, of the plurality of files in the data store based on the determined risk for each file.

15. The method of claim 14, wherein the protection policy comprises one or more of:
encrypting the file, or
reducing access permissions for one or more users of the network.

16. The method of claim 9, wherein communicating the one or more actions to a user comprises:
causing at least one action, of the one or more actions, to occur; and
notifying a user that the at least one action has occurred.

17. A system, comprising:
at least one device including a hardware processor;
the system being configured to perform operations comprising:
scanning a network associated with an entity to extract one or more features of the network;
classifying the entity based at least a portion of the one or more extracted features;
computing a risk to data in the network based on the one or more features and the entity classification;
determining one or more actions to mitigate the computed risk; and
communicating the one or more actions to a user.

18. The system of claim 17, wherein computing the risk comprises:
receiving one or more environmental characteristics of the entity;
determining one or more applicable regulations based on the entity classification and the one or more environmental characteristics of the entity;
assessing costs associated with loss or abuse of an individual data item stored on the network;
applying a non-additive model to determine costs associated with loss or abuse of a plurality of data items stored on the network; and
assessing a likelihood of a data breach based on one or more likelihood factors determined based on the one or more extracted features.

19. The system of claim 18, wherein the one or more actions to mitigate the computed risk are determined based on:
the determined likelihood of a data breach. and
one or more of:
the costs associated with loss or abuse of an individual data item, or
the costs associated with loss or abuse of a plurality of data items.

20. The system of claim 17, wherein scanning the network comprises:
extracting one or more characteristics associated with each file of a plurality of files in a data store, and
determining a similarity matrix indicating similarities between each file in the data store based on the extracted characteristics;
wherein computing the risk to the data in the network comprises:
analyzing content of a subset of the files in the data store,
computing a risk for each file in the subset of the files, and
determining a risk for all files based on the computed risk for the subset of the files and the similarity matrix; and
the operations further comprising applying a protection policy to one or more files, of the plurality of files in the data store based on the determined risk for each file.
